(19) United States
(12) Patent Application Publication
(10) Pub. No.: US 2009/0184493 A1
(43) Pub. Date: Jul. 23, 2009

(54) REMOVABLE TOW HOOKS AND TOW LOCKING SYSTEM

(75) Inventors: Michael J. Eifert, Fort Wayne, IN (US); Kevin L. Grady, Fort Wayne, IN (US); Matthew D. Friede, Fort Wayne, IN (US); Blaine L. Hershberger, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/016,496

(22) Filed: Jan. 18, 2008

(51) Int. Cl. B60D 1/14

(52) U.S. Cl. 280/491.5

(57) ABSTRACT

A removable tow device and tow device receiver is provided having lugs upon the removable tow device that engage lug pockets within the tow device receiver for secure engagement. The removable tow device and receiver are simple to use, requiring a minimal of manipulation to install. Installation is reduced to insert, twist, and release. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### BRIEF DESCRIPTION OF THE DRAWINGS

FIG. 1—A vehicle having removable tow devices.

FIG. 2—A vehicle chassis having removable tow devices.

FIG. 3—Removable tow device.

FIG. 4—Tow device receiver.

FIG. 5—Removable tow device inserted into tow device receiver.

FIG. 6—Tow device receiver with hold—forward spring.

FIG. 7—A vehicle chassis with integrated tow device receiver and front suspension mounts.

FIG. 8—Tow device receiver with sloped block and mating tow device feature, inserted.

FIG. 9—Tow device receiver with sloped block and mating tow device feature, engaged.

FIG. 10—Integrated tow device receiver and front suspension mount.

FIG. 11—Removable tow device with engagement and alignment indicators.

FIG. 12—Removable tow device having attached hold-forward spring.

### DETAILED DESCRIPTION OF THE INVENTION

Vehicles for operation on the ground are often provided with tow hooks or rings in order to provide a point to attach chains or other towing devices when pulling the vehicle. Some such tow hooks or rings are permanently affixed, so that they protrude from the front of the vehicle at all times. Others are removable, so as to allow the vehicle to comply with aerodynamic or impact absorption requirements. It is advantageous to provide removable tow devices that are simple to attach, do not require tools to do so, and do not require access to the area behind the vehicle bumper in order to insert a pin, clevis, fastener, or the like. It is also advantageous that the tow devices require a minimum of manipulation, such as repeated turning as a threaded fastener, and that once installed provide a robust attachment point.

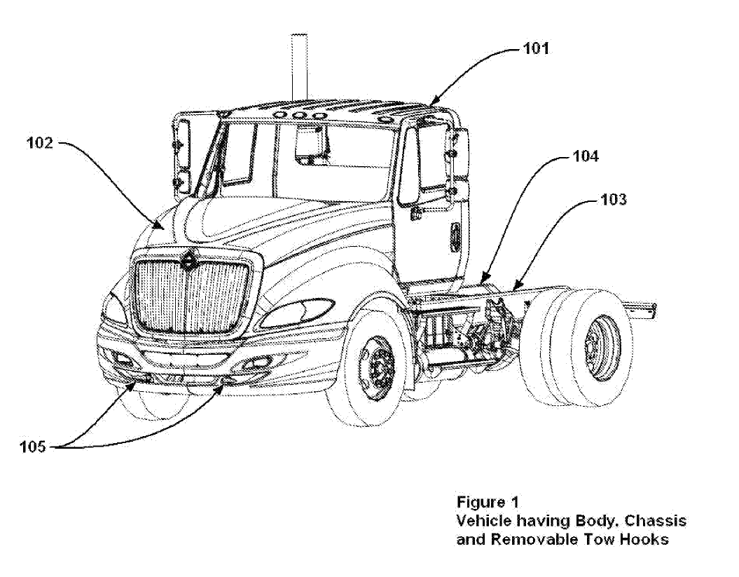

FIG. 1 shows a vehicle 101 having a body 102 and a chassis 103. The chassis 103 is comprised of a ladder-type vehicle frame 104. The vehicle 101 is provided with removable tow devices 105 that attach to the ladder-type vehicle frame 104 of the chassis 103 in a manner that is shown in subsequent drawings.

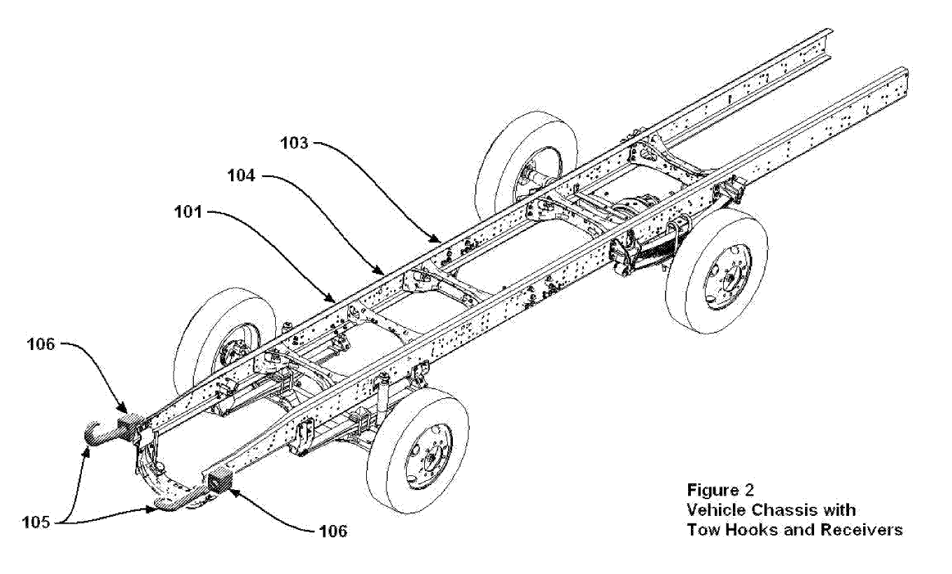

FIG. 2 shows a chassis 103 of a vehicle 101, similar to the vehicle 101 shown in FIG. 1. The chassis is again comprised of a ladder-type vehicle frame 104, to which ladder-type vehicle frame 104 are attached tow device receivers 106. Attachment of the tow device receivers 106 to the ladder-type vehicle frame 104 may be by means of bolt, rivet, or other conventional fastener. Removable tow devices 105 are insertable into the tow device receivers 106, such that the removable tow devices 105 are inserted and twisted approximately ninety degrees to securely lock them into place.

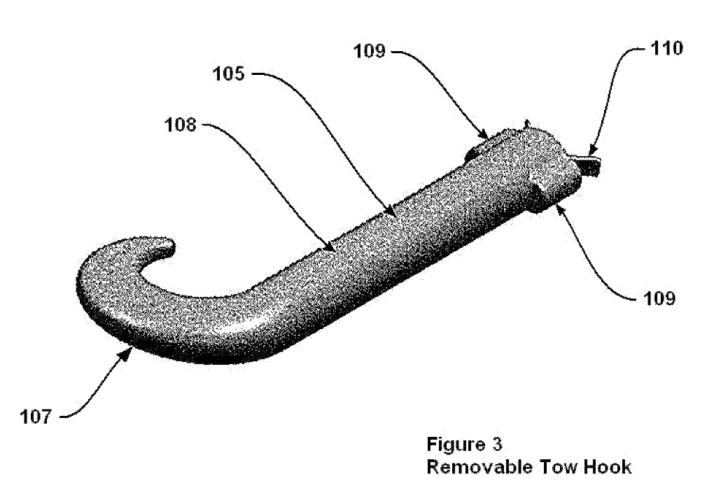

FIG. 3 shows a removable tow device 105 having an attachment feature 107, a shank 108, and lug lobes 109. The attachment feature 107 may be a hook as shown, or it may be in the form of a ring. Two lug lobes 109 are shown, but a single lug lobe 109 may be used to the same effect. A hold-forward spring 110 is partially visible, and will be shown to greater clarity in subsequent views.

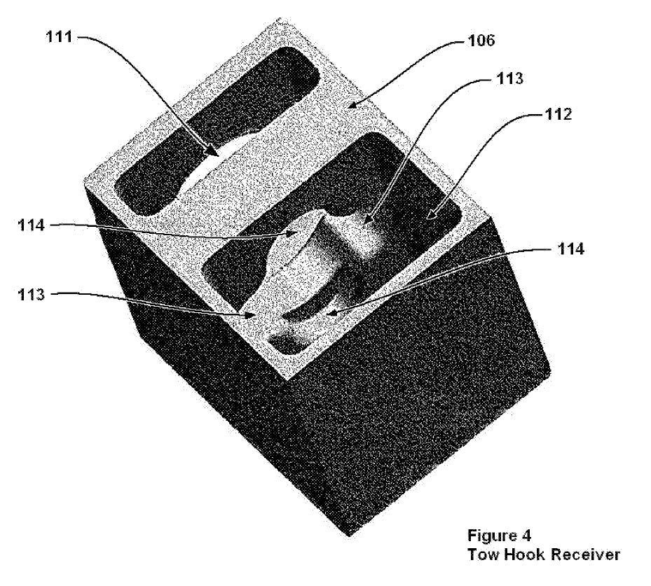

FIG. 4 shows a tow device receiver 106, simplified in the sense that any mounting flanges or features that may be present are not shown. The tow device receiver 106 in FIG. 4 is also shown with one side open, although it may well be closed on all sides. The tow device receiver 106 is provided with a receiver hole 111 which is shaped to admit the removable tow device 105 (not shown), and which is only partially visible in FIG. 4. The interior of the tow device receiver 106 is provided with a receiver cavity 112, into which the receiver hole 111 opens. As illustrated, the receiver hole 111 may open directly into the receiver cavity 112, or may pass through additional cavities in the tow device receiver 106, according to construction, weight, and strength requirements. The receiver hole 111 possesses lobe clearance-ways 113 and, on the inner forward wall of the receiver cavity 112, lobe pockets 114. When the removable tow device 105 (not shown) is inserted into the tow device receiver 106, the lug lobes 109 pass through the lobe clearance-ways 113. The removable tow device 105 is inserted sufficiently far that the hold-forward spring 110 (not shown) is compressed, then the removable tow device 105 is turned ninety degrees. The lug lobes 109 then engage the lobe pockets 114 and are held in such engagement by the hold-forward spring 110 (not shown).

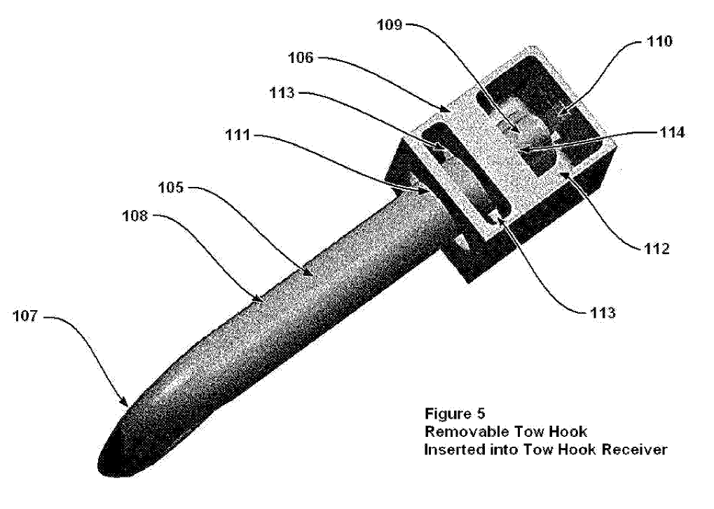

FIG. 5 shows a tow device receiver 106 with a removable tow device 105 inserted therein. The removable tow device 105 is again provided with an attachment feature 107, a shank 108, and lug lobes 109. The tow device receiver 106 is again provided with a receiver hole 111, lobe clearance-ways 113, and a receiver cavity 112. A hold-forward spring 110 is attached to the end of the removable tow device 105, and engages the rearmost wall of the receiver cavity 112, so that once the removable tow device 105 is inserted through the receiver hole 111 with the lug lobes 109 aligned with the lobe clearance-ways 113, the removable tow device 105 is rotated ninety degrees and the hold-forward spring 110 forces the lug lobes 109 into engagement with the lobe pockets 114. Note that the lobe pockets 114 are not visible in FIG. 5.

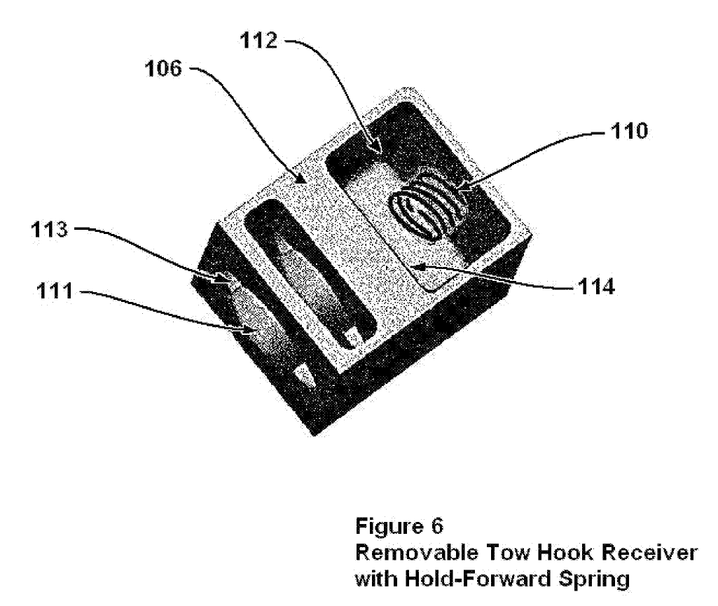

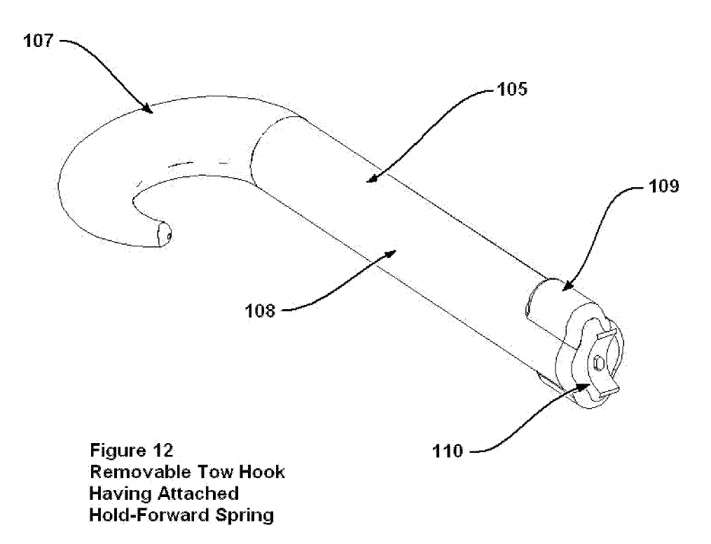

FIG. 6 shows a tow device receiver 106, again having a receiver hole 111, a receiver cavity 112, lobe clearance-ways 113, and lobe pockets 114. Note that the lobe pockets 114 are not visible in FIG. 6. A hold-forward spring 110 is attached to the rearmost wall of the receiver cavity 112, and performs the same function as the hold forward spring 110 attached to the removable tow device 105 in FIG. 5. The hold-forward spring 110 may be a coil spring as shown, or may be a leaf spring similar to the hold forward spring 110 shown in FIG. 12.

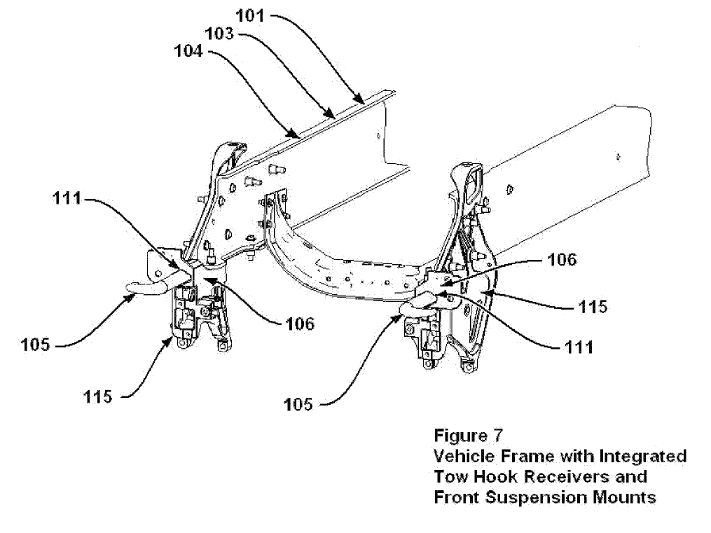

FIG. 7 shows a chassis 103 of a vehicle 101 comprising a ladder-type vehicle frame 104. Removable tow devices 105 are shown inserted into the receiver holes 111 of tow device receivers 106, which tow device receivers 106 are integrated tow device receiver and front suspension mounts 115. The integrated tow device receiver and front suspension mounts 115 shown in FIG. 7 are shown as castings. However, they may be welded steel constructs or other similar robust construction.

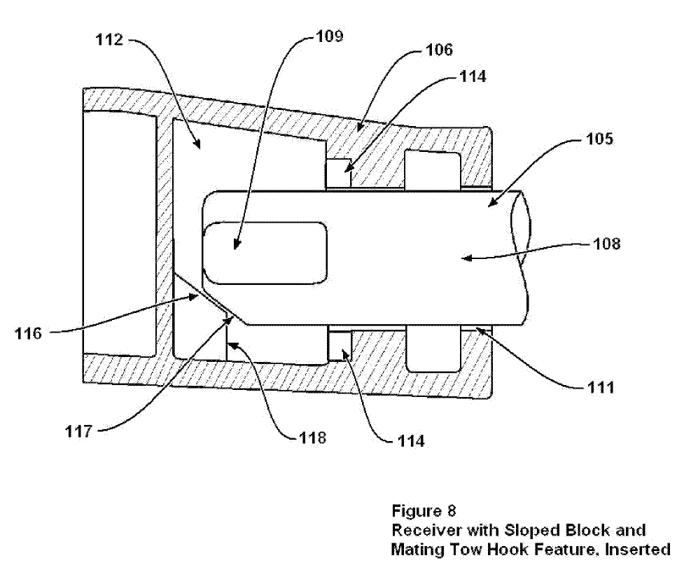

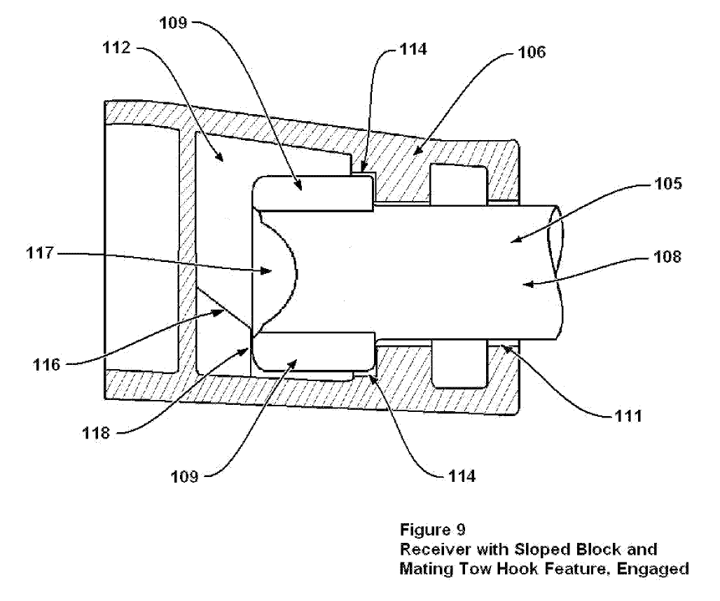

FIG. 8 shows a cross-sectional view of an embodiment of a tow device receiver 106. The tow device receiver 106 again has a receiver hole 111 so shaped as to admit a removable tow device 105 having a shank 108 and lug lobes 109, and also has a receiver cavity 112 with lobe pockets 114. In addition, the tow device receiver 106 in FIG. 8 is provided with a receiver cavity inclined surface 116. A similarly angled tow device inclined surface 117 is provided upon the end of the removable tow device 105. The receiver cavity inclined surface 116 terminates at its forward edge to adjoin with a receiver cavity engagement wall 118, the purpose of which receiver cavity inclined surface 116, tow device inclined surface 117, and receiver cavity engagement wall 118 will become apparent in FIG. 9. Note that although the receiver cavity inclined surface 116 and tow device inclined surface 117 are shown as planar surfaces, they may be non-planar, as will be elaborated in FIG. 9.

FIG. 9 shows another cross-sectional view of an embodiment of a tow device receiver 106, similar to the tow device receiver 106 shown in FIG. 8. The tow device receiver 106 again has a receiver hole 111 so shaped as to admit a removable tow device 105 having a shank 108 and lug lobes 109, and also has a receiver cavity 112 with lobe pockets 114. A similar receiver cavity inclined surface 116 and tow device inclined surface 117 are provided, as well as a receiver cavity engagement wall 118. The removable tow device 105 is shown rotated ninety degrees, so that the receiver cavity inclined surface 116 and the tow device inclined surface 117 have cooperated to force the lug lobes 109 into the lobe pockets 114 upon rotation of the removable tow device 105. The lug lobes 109 are held in engagement with the lobe pockets 114 by the receiver cavity engagement wall 118. Note that the receiver cavity inclined surface 116 and tow device inclined surface 117 are again shown as planar surfaces, though they may be non-planar in order to provide clearance as the removable tow device 105 is rotated and the lug lobes 109 enter into the lobe pockets 114. In order to accomplish this, the receiver cavity inclined surface 116 and tow device inclined surface 117 may describe a segment of a complex convolute, such as a helix. Also, it may be appreciated that the lobe pockets 114 may also by asymmetric, so as to accommodate the rotating entry of the lug lobes 109.

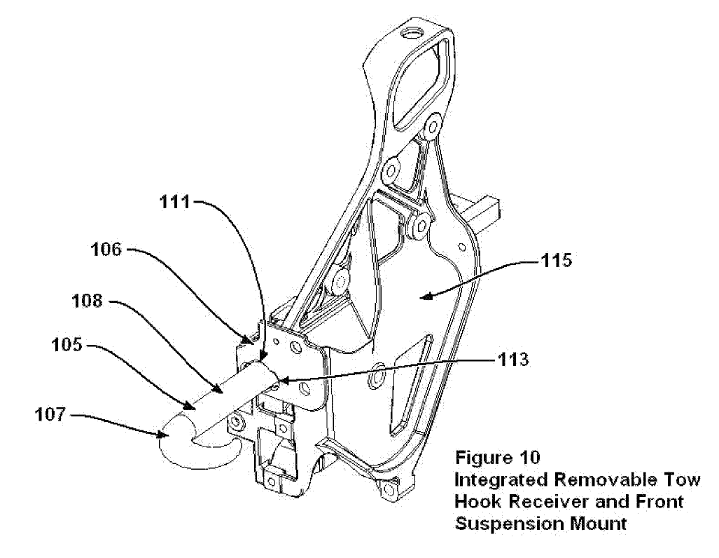

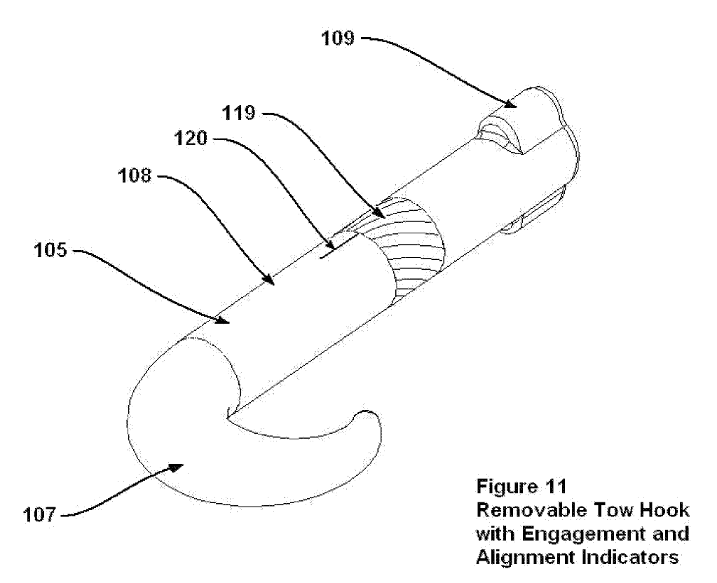

FIG. 10 shows a tow device receiver 106 in the form of an integrated tow device receiver and front suspension mount 115, similar to the integrated tow device receiver and front suspension mount 115 shown in FIG. 7. The integrated tow device receiver and front suspension mount 115 shown in FIG. 10 is provided with a receiver hole 111 having lobe clearance-ways 113, as well as features not visible in FIG. 10, such as a receiver cavity 112, and lobe pockets 114. The integrated tow device receiver and front suspension mount 115 may also be provided with a hold-forward spring 110 or a receiver cavity inclined surface 116 and receiver cavity engagement wall 118. A removable tow device 105 is shown inserted into the receiver hole 111, which removable tow device 105 is provided with an attachment feature 107, a shank 108, and lug lobes 109 (not visible in FIG. 10). The removable tow device 105 may also be provided with a hold-forward spring 110 or tow device inclined surface 117, depending upon the configuration of the integrated tow device receiver and front suspension mount 115. Note that the removable tow device 105 shown in FIG. 10 is shown in an installed position that is different from the installed position that would result from the configuration of the removable tow devices 105 shown in FIGS. 3 and 5. Specifically, the lug lobes 109 shown on the removable tow devices 105 shown in FIGS. 3 and 5 are shown axially aligned with the plane of the attachment feature 107. The lug lobes 109 are not visible in FIG. 10, but are aligned axially ninety degrees from the plane of the attachment feature 107. Removable tow devices 105 of this configuration are shown in FIGS. 11 and 12. An advantage of so orienting the lug lobes 109 ninety degrees from the plane of the attachment feature 107 is that the weight of the attachment feature 107 tends to rotate the removable tow device 105 towards alignment of the lug lobes 109 with the lobe pockets 114, which lobe pockets 114 may be provided with stops to prevent over-rotation.

FIG. 11 shows a removable tow device 105 having an attachment feature 107, a shank 108, and lug lobes 109. Note that the lug lobes 109 are aligned axially ninety degrees from the plane of the attachment feature 107, as mentioned in the detailed description of FIG. 10. The shank 108 of the removable tow device 105 is provided with an engagement indicator 119 and an alignment indicator 120, which assists in verifying that the removable tow device 105 is securely engaged.

FIG. 12 shows a removable tow device 105 having an attachment feature 107, a shank 108, and lug lobes 109. The removable tow device 105 is also provided with a hold-forward spring 110. The hold-forward spring 110 may be a leaf spring as shown or a coil spring similar to the hold-forward spring 110 shown in FIG. 6. Alternately, the hold-forward spring 110 attached to the removable tow device 105 may be located in a recess in the end of the removable tow device 105 (not shown), and may be provided with a plunger and a threaded retaining sleeve (not shown). Such embodiment would operate by compressing the captured spring when the plunger came into contact with the rearmost wall of the receiver cavity 112, thereby forcing the lug lobes 109 of the removable tow device 105 into the lobe pockets 114.

While specific embodiments have been described in detail in the foregoing detailed description and illustrated in the accompanying drawings, those with ordinary skill in the art will appreciate that various permutations of the invention are possible without departing from the teachings disclosed herein. Accordingly, the particular arrangements disclosed are meant to be illustrative only and not limiting as to the scope of the invention, which is to be given the full breadth of the appended claims and any and all equivalents thereof. Other advantages to a vehicle equipped with removable tow devices and a removable tow device locking system may also be inherent in the invention, without having been described above.

We claim:

1. A vehicle for operation on the ground comprising:
a body;
a chassis, said chassis having a frame;
at least one tow device receiver, said at least one tow device receiver being attached to said frame and having a receiver hole, said receiver hole having at least one lobe clearance-way, said tow device receiver having a receiver cavity with a forward wall and a rearward wall, into which receiver cavity said receiver hole opens, said receiver cavity having at least one lobe pocket located in said forward wall; and
at least one removable tow device, said at least one removable tow device having an attachment feature, a shank, and at least one lug lobe upon said shank.

2. The vehicle for operation on the ground of claim 1, wherein:
said at least one tow device receiver further comprises an integrated tow device receiver and front suspension mount.

3. The vehicle for operation on the ground of claim 2, wherein:
said integrated tow device receiver and front suspension mount is manufactured using a casting process.

4. The vehicle for operation on the ground of claim 2, wherein:
said integrated tow device receiver and front suspension mount is manufactured using a welding process.

5. The vehicle for operation on the ground of claim 1, wherein:
said receiver hole has two lobe clearance-ways and two lobe pockets; and
said removable tow device has two lug lobes upon said shank.

6. The vehicle for operation on the ground of claim 5, wherein:
said lug lobes upon said shank of said removable tow device are located axially about ninety degrees from a plane defined by said attachment feature.

7. The vehicle for operation on the ground of claim 5, wherein:
said lobe pockets are provided with stops to prevent over-rotation of said removable tow device.

8. The vehicle for operation on the ground of claim 1, wherein:
said at least one tow device receiver is provided with a hold-forward spring, said hold-forward spring being located upon said rearward wall of said receiver cavity.

9. The vehicle for operation on the ground of claim 8, wherein:
said hold-forward spring is a leaf spring.

10. The vehicle for operation on the ground of claim 8, wherein:
said hold-forward spring is a coil spring.

11. The vehicle for operation on the ground of claim 1, wherein:
said at least one removable tow device is provided with a hold-forward spring.

12. The vehicle for operation on the ground of claim 11, wherein:
said hold-forward spring is a leaf spring.

13. The vehicle for operation on the ground of claim 11, wherein:
said hold-forward spring is a coil spring.

14. The vehicle for operation on the ground of claim 11, wherein:
said removable tow device is provided with a recess for said hold-forward spring, said hold-forward spring being located in said recess, said removable tow device being further provided with a plunger and a retaining sleeve, said plunger operating to compress said hold-forward spring when depressed.

15. The vehicle for operation on the ground of claim 1, wherein:
said receiver cavity in said at least one tow device receiver is provided with an inclined surface adjacent to said rearward wall and an engagement wall adjoining said inclined surface;
said at least one removable tow device having a similarly angled inclined surface;
said inclined surface in said receiver cavity and said similarly angled inclined surface upon said at least one removable tow device being operable upon rotation of said at least one removable tow device to force said at least one lug lobe upon said shank of said at least one removable tow device into said at least one lobe pocket, and said engagement wall being operable to hold said at least one lug lobe in engagement with said at least one lobe pocket.

16. The vehicle for operation on the ground of claim 15, wherein:
said inclined surface in said receiver cavity describing a segment of a complex convolute.

17. The vehicle for operation on the ground of claim 15, wherein:
said at least one lobe pocket being asymmetrical.

18. The vehicle for operation on the ground of claim 1, wherein:
said at least one removable tow device having an indication upon said shank for determining a fully inserted and aligned condition of said at least one removable tow device into said at least one tow device receiver.

19. The vehicle for operation on the ground of claim 1, wherein:
said attachment feature upon said at least one removable tow device further comprises a hook.

20. The vehicle for operation on the ground of claim 1, wherein:
said attachment feature upon said at least one removable tow device further comprises a ring.
